(19) United States
(12) Patent Application Publication
(10) Pub. No.: US 2007/0171388 A1
(43) Pub. Date: Jul. 26, 2007

(54) PROJECTION APPARATUS HAVING SINGLE REFLECTIVE LIGHT VALVE

(75) Inventors: Shen-Huei Wang, Miao-Li County (TW); Sze-Ke Wang, Miao-Li County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CORETRONIC CORPORATION, Miao-Li County (TW)

(21) Appl. No.: 11/564,297

(22) Filed: Nov. 29, 2006

(30) Foreign Application Priority Data
Jan. 24, 2006 (TW) 95102572

(51) Int. Cl. G03B 21/14

(52) U.S. Cl. 353/101

(57) ABSTRACT

A projection apparatus having a single reflective light valve is provided. The projection apparatus includes a non-telecentric illumination system, a movable projection lens and a reflective light valve. The non-telecentric illumination system includes a light source and a lens. The light source is suitable for providing a light beam and the lens is disposed on the transmission path of the light beam. The movable projection lens is disposed behind the lens on the transmission path of the light beam for projecting an image. An image projected from the projection apparatus has an offset between 100%˜150%. The reflective light valve is disposed between the lens and the movable projection lens on the transmission path of the light beam. The reflective light valve has rows of horizontally arranged pixels.

### CROSS-REFERENCE TO RELATED APPLICATION

This application claims the priority benefit of Taiwan application serial no. 95102572, filed Jan. 24, 2006. All disclosure of the Taiwan application is incorporated herein by reference.

### BACKGROUND OF THE INVENTION

1. Field of the Invention

The present invention relates to a projection apparatus. More particularly, the present invention relates to a projection apparatus having a single reflective light valve.

2. Description of the Related Art

FIG. 1 is a structural diagram of a conventional projection apparatus having single reflective light valve. FIG. 2 is a diagram showing an image offset of the conventional projection apparatus in FIG. 1. As shown in FIGS. 1 and 2, the projection lens 100 with image offset capability includes a digital micro-mirror device (DMD) 110, a movable projection lens 120 and a telecentric illumination system 130. The light source in the telecentric illumination system 130 is suitable for providing a light beam 132a. The movable projection lens is disposed on the transmission path of the light beam 132a. The telecentric illumination system 130 is disposed between the digital micro-mirror device 110 and the movable projection lens 120. The telecentric illumination system 130 has a total internal reflection prism (TIR prism) 134 in front of the digital micro-mirror device 110 on the transmission path of the light beam 132a. The light beam 132a from the light source 132 is reflected by the total internal reflection prism 134 to the digital micro-mirror device 110 and then projected an image 140 onto a screen S via the movable projection lens 120.

The movable projection lens 120 moves up or down along the Z axis or moves left or right along the X axis, the projection apparatus has an image offsetting capability. However, the telecentric illumination system 130 with this structure needs to have a more expensive total internal reflection prism 134. Moreover, the light beam 132a disperses after passing through the digital micro-mirror device 110. Consequently, there is a need to use a larger movable projection lens 120 to collect the light beam 132a so that the production cost of the projection apparatus 100 is increased. Similarly, the size of the movable projection lens has to be increased when a large image offsetting capability is required. Again, the cost of producing the projection lens 120 is increased.

To prevent any substantial increasing in the production cost of the movable projection lens 120, the size of a movable projection lens is often stringently restricted. However, due to the size restriction, the offsetting range cannot be too large. Thus, the degree of offset for the image 140 is smaller than 100%. In general, the degree of offset is calculated using the formula {[A+B}/A}×100%. In other words, it is rather inconvenient to use the projection apparatus 100 having single reflective light valve in a situation that requires a large angular projection.

As a result, there is always a need for a projection apparatus having a larger projection offset but a lower production cost.

### SUMMARY OF THE INVENTION

Accordingly, the present invention is to provide a projection apparatus having single reflective light valve that has a lower production cost and a larger projection offset.

As embodied and broadly described herein, the invention provides a projection apparatus having single reflective light valve suitable for projecting along a vertical line in the gravity direction. The projection apparatus having single reflective light valve, which comprises a non-telecentric illumination system, a movable projection lens and a reflective light valve is provided. The non-telecentric illumination system includes a light source and a lens. The light source is suitable for providing a light beam and the lens is disposed on the transmission path of the light beam. The movable projection lens is disposed behind the lens on the transmission path of the light beam for projecting an image. The movable projection lens moves away from the lens in a perpendicular direction so that an image projected from the projection apparatus has an offset between 100%˜150%. The reflective light valve is disposed between the lens and the movable projection lens on the transmission path of the light beam. The reflective light valve has rows of horizontally arranged pixels.

The reflective light valve is a digital micro-mirror device or a liquid crystal on silicon panel, for example. The lens is a transparent lens, for example. However, the lens can also be a reflective mirror. The lens is disposed under the movable projection lens and the upper edge of the lens adjacent to the movable projection lens has a recess. The light beam converges at a point about 10 mm˜100 mm in front of the reflective light valve. Furthermore, the amount of projection offset of the image can also be between −100%˜−150%.

In brief, the present invention deploys a non-telecentric illumination system with a production cost lower than the telecentric illumination system. Moreover, the movable projection lens in the projection apparatus having single reflective light valve of the present invention moves along a perpendicular line so that the image projected from the apparatus has an offset between 100%˜150%.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a structural diagram of a conventional projection apparatus having single reflective light valve.

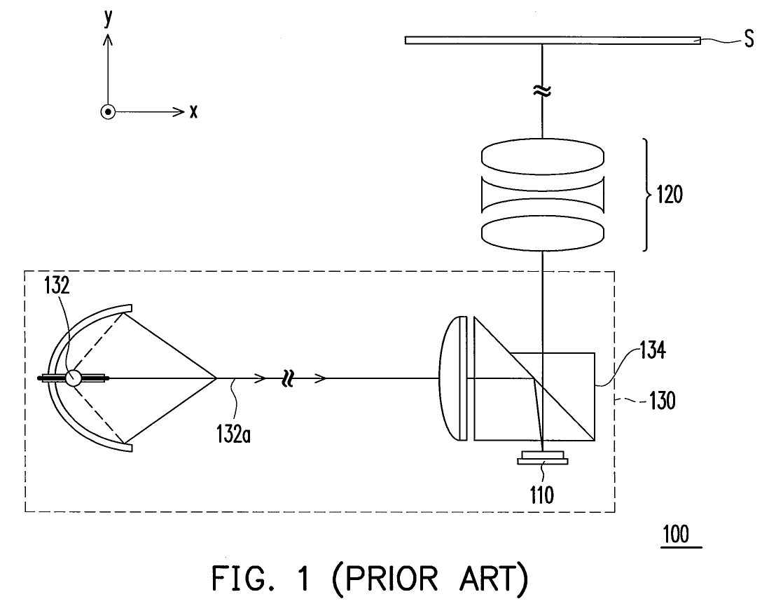

FIG. 2 is a diagram showing an image offset of the conventional projection apparatus in FIG. 1.

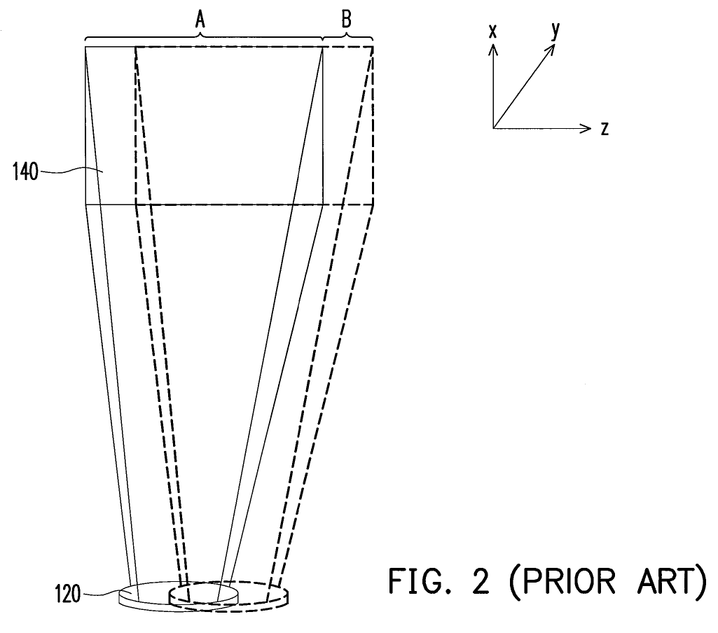

FIG. 3 is a structural diagram of a projection apparatus having single reflective light valve according to one embodiment of the present invention.

FIG. 4 is a diagram showing an image produced by the projection apparatus having single reflective light valve shown in FIG. 3.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

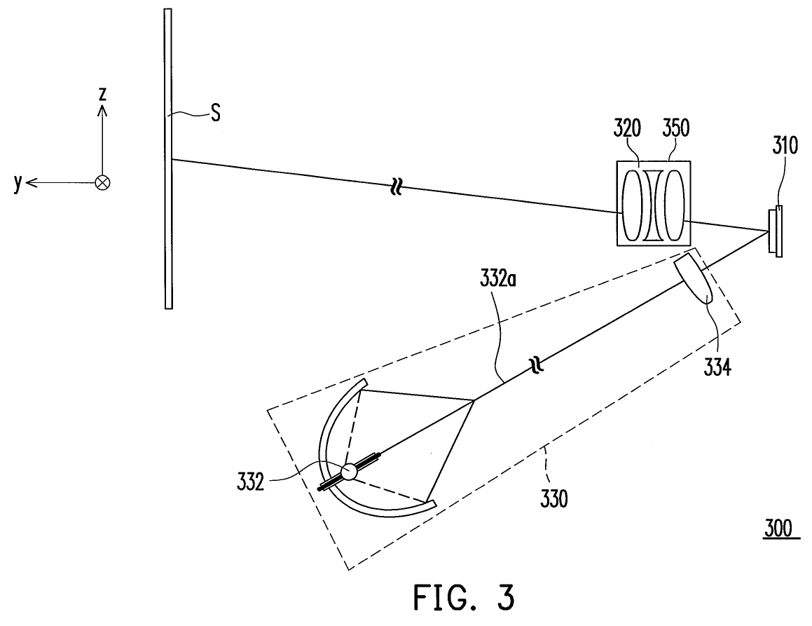

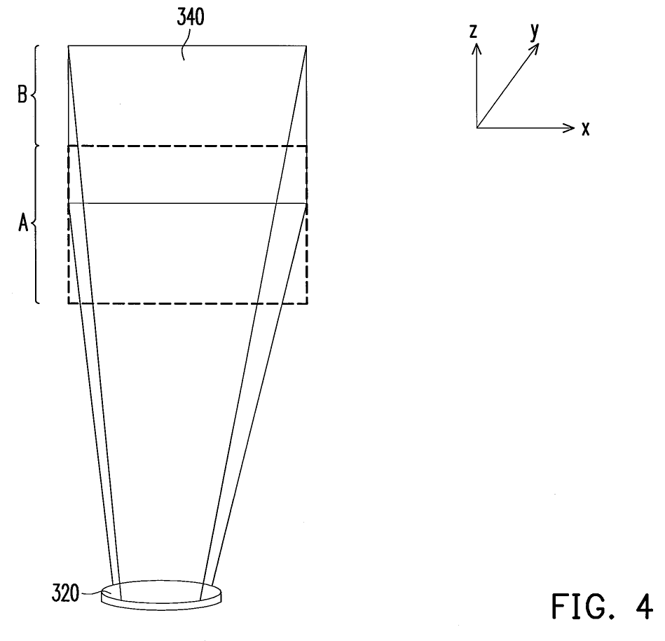

FIG. 3 is a structural diagram of a projection apparatus having single reflective light valve according to one embodiment of the present invention. FIG. 4 is a diagram showing an image produced by the projection apparatus having single reflective light valve as shown in FIG. 3. As shown in FIGS. 3 and 4, a projection apparatus having single reflective light valve 300 in the present embodiment is suitable for projecting an image along a vertical line (Z axis) in a gravity direction. The projection apparatus having single reflective light valve 300 includes a reflective light valve 310, a movable projection lens 320 and a non-telecentric illumination system 330. The non-telecentric illumination system 330 includes a light source 332 and a lens 334. The light source 332 is suitable for providing a light beam 332a and the lens 334 is disposed on the transmission path of the light beam 332a. Moreover, the lens 334 is disposed directly underneath the movable projection lens 320. The light beam 332a from the non-telecentric illumination system 330 passes through the lens 334 and is incident upon the reflective light valve 310. Then, the light beam 332a reflected from the reflective light valve 310 to the movable projection lens 320 is converged at a point about 10 mm ˜100 mm in front of the reflective light valve 310. In addition, the movable projection lens 310 is disposed behind the lens 334 on the transmission path of the light beam 332a so that an image 340 is projected onto a screen S. In the present embodiment, the movable projection lens 320 moves up (away from the direction of the lens) along the vertical line (Z axis) so that the projected image 340 by the movable projection lens 320 moves up along the vertical line (Z axis) flexibly. The movable projection lens 320 is manually or automatically adjusted to a predetermined position through a moving device 350. The projection offset of the projected image 340 in the present embodiment is between 100%˜150%. Since the method of calculating the offset is similar to aforesaid, a detailed description is not repeated. The reflective light valve 310 is disposed between the lens 334 and the movable projection lens 320 on the transmission path of the light beam 332a. Moreover, rows of pixel units are arranged on the XZ plane of the reflective light valve 310.

Particularly, to prevent interference between the lens 334 and the movable projection lens 320 due to their setup positions, the upper edge of the lens 334 is normally cut to produce a recess. With the recess in the upper edge of the lens 334, it is no mutual interference between the setup locations of the movable projection lens 320 and the lens 334.

The lens 334 is a relay lens or a reflecting mirror, for example. The reflective light valve 310 is a digital micro-mirror device or a liquid crystal on silicon panel (LCOS panel), for example. In the present embodiment, the reflective light valve 310 is a digital micro-mirror device with many pixel units. The pixel units are set either to an ON state or an OFF state. When the light beam 332a is incident upon the reflective light valve 310, the ON state pixel units reflects the light beam 332a to the movable projection lens 320. Meanwhile, the light beam 332a incident upon the pixel units in the OFF state is not reflected to the movable projection lens 320.

In the present embodiment, when the image 340 projected from the projection apparatus having single reflective light valve 300 needs a downward offset, the entire projection apparatus having single reflective light valve 300 is inverted. Then, image processing software is activated to convert the image into an erect image displayed on the screen S. Therefore, the projected image 340 of the projection apparatus 300 having single reflective light valve in the present embodiment has a projection offset between −100%˜−150% beside the normal projection offset between 100%˜150%.

In summary, the present invention deploys a non-telecentric illumination system rather than the more expensive total internal reflection prism. Hence, the production cost is lower than a telecentric illumination system. Furthermore, the light beam from the non-telecentric illumination system is converged after reflection by the reflective light valve. Therefore, cost is saved by using a smaller movable projection lens to intercept the light beam. As a result, the projection apparatus having single reflective light valve in the present invention has a lower production cost compared with a conventional projection apparatus having single reflective light valve. Moreover, the movable projection lens in the projection apparatus having single reflective light valve of the present invention moves along a vertical line in a gravity direction so that the projection apparatus has an image projection offset between 100%˜150%. In other words, the image has an offset between 100%˜150% along the vertical line.

In addition, the projected image from the projection apparatus having single reflective light valve produces an offset between −100%˜−150% after inverting the projection apparatus having single reflective light valve. In other words, the image has a downward offset between 100%˜150% after using image processing software to produce an erect image on the display screen.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A projection apparatus having single reflective light valve for projecting an image along a vertical line in a gravity direction, comprising:
a non-telecentric illumination system, comprising:
a light source for providing a light beam; and
a lens disposed on the transmission path of the light beam;
a movable projection lens disposed behind the lens on the transmission path of the light beam to project the image, wherein the movable projection lens moves in a direction away from the lens along the vertical line, the offset of a projected image is between 100%˜150%; and
a reflective light valve disposed between the lens and the movable projection lens on the transmission path of the light beam, wherein the reflective light valve have a plurality of rows of pixel units arranged in a horizontal direction.

2. The projection apparatus having single reflective light valve of claim 1, wherein the reflective light valve comprises a digital micro-mirror device or a liquid crystal on silicon panel.

3. The projection apparatus having single reflective light valve of claim 1, wherein the lens comprises a transparent lens.

4. The projection apparatus having single reflective light valve of claim 1, wherein the lens comprises a reflective mirror.

5. The projection apparatus having single reflective light valve of claim 1, wherein the light beam is converged at a position between 10 mm˜100 mm in front of the reflective light valve.

6. The projection apparatus having single reflective light valve of claim 1, wherein the offset of the projected image is between −100%˜−150%.

7. The projection apparatus having single reflective light valve of claim 1, wherein the lens is disposed under the movable projection lens and an upper edge of the lens adjacent to the movable projection lens has a recess.
